(19) United States
(12) Patent Application Publication
(10) Pub. No.: US 2007/0288369 A1
(43) Pub. Date: Dec. 13, 2007

(54) Method for payment processing, billhead for payment processing, billhead generation facility and facility for communicating with a financial institution

(75) Inventors: Markus Moser, Graz (AT); Martin Pelzmann, Graz (AT)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS AKTIENGESELLSCHAFT

(21) Appl. No.: 11/803,489

(22) Filed: May 15, 2007

(30) Foreign Application Priority Data
May 15, 2006 (EP) 06009992.6

(51) Int. Cl. G06Q 40/00

(52) U.S. Cl. 705/40

(57) ABSTRACT

In one aspect, a method for payment processing, wherein an entity issuing an invoice creates a payment form to be sent to a debtor, with the data required to process the payment being input on the form by the issuing entity, a first short-range radio transmit/radio receive facility with a storage facility being integrated into the payment form is provided. The necessary data is also stored permanently on the storage facility in such a manner that, when the form is located within the short-range radio transmit/radio receive area of a facility embodied with a second short-range radio transmit/radio receive facility and communicating with a financial institution, it transmits the stored data after detecting a first initiating action. Other aspects include a billhead generation facility, a billhead and a facility for communicating with a financial institution, which is embodied to implement the method.

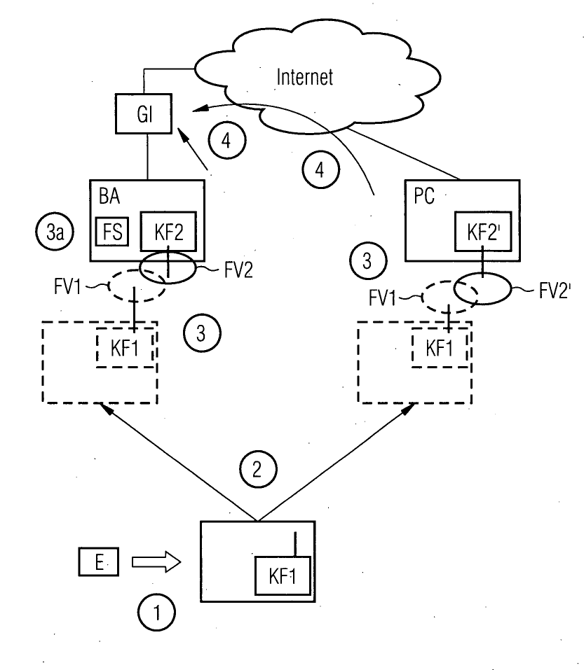

### CROSS REFERENCE TO RELATED APPLICATIONS

This application claims priority of European application No. 06009992.6 EP filed May 15, 2006, which is incorporated by reference herein in its entirety.

### FIELD OF INVENTION

The invention relates to a method for payment processing, a billhead generation facility, a billhead, and a facility for communicating with a financial institution.

### BACKGROUND OF INVENTION

The growth of the internet has made the processing of transactions by way of said medium, in particular the making of payments by way of what is known as electronic or online banking, accessible to many people. As well as being able to process payment orders, it is also possible, as before, to process transactions associated with the bank, such as taking out money, checking account status information and also processing payments at financial institution terminals associated with the banks, also known as ATMs or cash machines.

### SUMMARY OF INVENTION

One disadvantage of processing payments in this manner is that the invoices often issued by companies are sent to the respective debtor together with a standard payment form for such transactions that has already been filled in and, if the payment is not made at a bank counter, this information has to be input into said systems, in other words the bank ATM or online or internet banking by way of input screens or special programs. This is both time-consuming and prone to error.

An object underlying the invention is to specify a comparatively better method and the facilities required for this.

This object is achieved based on the independent claims.

With the inventive method for payment processing, wherein a payment form to be sent to a debtor is created by an entity issuing an invoice, with the data required to process the payment being input by the issuing entity on the form, a first short-range radio transmit/radio receive facility with a storage facility is integrated in the payment form. The necessary data is also stored permanently on the storage facility, in such a manner that, when the form is located within the short-range radio transmit/radio receive area (radio coverage area) of a facility embodied with a second short-range radio transmit/radio receive facility and communicating with a financial institution, it transmits the stored data after detecting a first initiating action.

It is an advantage of this inventive method that a payment can be processed by way of internet banking or bank ATMs in a shorter time and without keying errors. The use of short-range radio transmit/radio receive facilities here means that the user has to be located in a near field of said payment processing facilities, such that random triggering of the payment is prevented and at the same time an attack by an unauthorized third party, with the aim of intercepting the data or obtaining account-relevant data by observing the terminal for example, is prevented, as the user as usual has to be located, as before, preferably in front of the device display unit, so that said user is detected and the third party would also have to move in the near field and would therefore be visible. As a standard payment form is used, in which an inventive short-range radio transmit/radio receive facility is simply integrated, said form can also alternatively be used, as before, for standard payment procedures at the counters of financial institutions.

According to a development of the method, initiation is preferably triggered by entry into the near field. This has the advantage that the payment procedure is generally free of time-consuming actions. This also has a security aspect, as the user does not have to remove the form from its repository, so an unauthorized third party does not obtain access to data or even the form itself.

Alternatively or additionally initiation thereby takes place by means of user details at the facility communicating with the financial institution and/or at the form itself, with the data preferably being input automatically in an input screen provided by the facility, after it has been transmitted. It is an advantage of these embodiments that the user still has a control option and can abort the payment procedure if required. This is particularly important, if the intention is to prevent the transfer being triggered more than once, simply due to the user passing such a facility a number of times, with the near field of the short-range radio transmit/radio receive facility for example not being sufficient, so that a payment is triggered each time said user passes.

In a further advantageous embodiment of the method, biometric data of the user, in particular fingerprints, is captured, said data of the user is compared with stored biometric user data and if it corresponds to the stored data, the payment is forwarded to the financial institution for processing. One advantage of this procedure is the increased protection against third-party abuse.

The facility is thereby preferably operated as a bank ATM communicating with a bank communication network or alternatively or additionally as a computer connected by way of a communication network, in particular to the internet, in such a manner that the user does not have to switch to new procedures, thereby increasing user-acceptance.

In a development of the inventive method further data stored by the entity on the storage medium is transmitted to the facility and displayed, in addition to the required data, in such a manner that a user can read it and must confirm the reading thereof. One advantage of this procedure is that the user can be provided on the one hand with legal information or tips and/or information from the issuing entity, for example with new products, etc., can be presented to the customer, in such a manner that the additional costs resulting from integrating the short-range radio transmit/radio receive facility into the payment form can hereby be refinanced by such advertising measures. The payment form is preferably created as a form accepted by financial institutions, so that no adjustments are required on the part of the financial institution, thereby increasing acceptance of the inventive method by the financial institutions.

The object is also achieved by a billhead generation facility for payment processing, which is characterized by means for generating a billhead, as required for the method.

The object is also achieved by a billhead, which is used according to the method.

The first short-range radio transmit/radio receive facility is thereby preferably embodied as what is known as a radio frequency identification (RFID) chip. It is advantageous here that said chips are on the one hand produced in very large numbers and can therefore be purchased favorably. They also have a small information storage unit, which is fully adequate to support the inventive method and is also embodied with such small dimensions that it can be integrated into known payment forms in a largely problem-free manner. It is preferable here for the radio coverage area to be embodied such that it defines the near field, in particular by restriction of its transmit power. One advantage of this embodiment is that the first short-range radio transmit/radio receive facility used already helps to protect the payment procedure, in that it reduces the radius of the radio coverage area (radio transmit/radio receive area) to a minimum, thereby preventing abuse and unwanted payment initiation. This development is preferably used, when short-range radio transmit/radio receive facilities other than said RFID chips are used, since these generally have a larger radio transmit/radio receive coverage area than the RFID chips.

The object is also achieved by a facility for communicating with a financial institution, in particular a bank ATM, which has means for implementing the method. This will preferably have a second short-range radio transmit/radio receive facility, which is embodied such that its radio coverage area defines the near field, in particular by restriction of its transmit power. This also makes it possible to ensure that unwanted payments are not made and possible attacks by third parties are reduced. It also has the advantage that the reduction of radio coverage areas has to take place at few central locations and thus, when integrating first short-range radio transmit/radio receive facilities, products already available on the market can be used without modification, thereby allowing a favorable purchase, resulting in greater acceptance by the issuing entities.

### BRIEF DESCRIPTION OF THE DRAWING

Further details and advantages of the invention are described in more detail with reference to the single FIGURE. This FIGURE shows a schematic diagram of the inventive method based on the inventive arrangements.

The FIGURE shows a schematic diagram of the inventive procedure based on the facilities implementing it.

### DETAILED DESCRIPTION OF INVENTION

In the case of the exemplary embodiment illustrated, the starting point is a first step 1, wherein an entity E creates a form VD for payment processing, shown schematically by the block-type arrow. Such creation thereby presupposes a service or another transaction establishing a contractual relationship, which has resulted in a customer becoming a debtor, owing something to the entity and therefore being the recipient of said form VD.

As can be seen, the entity E integrates a first short-range radio transmit/radio receive facility KF1 into the form VD. When the customer receives said form, said customer can initiate payment processing. According to the invention it is hereby advantageous that the payment form corresponds to a standard form for such transactions, such that the customer is able either to effect the payment directly at the financial institution at a counter or by placing it in a box provided there for this purpose or, as shown in the FIGURE, in a second step 2, to make the payment by way of a bank ATM BA, which is connected directly to a financial institution GI, or a PC, which is connected by way of the internet to the financial institution GI.

The PC, which will generally be the home computer of the customer, will have a second short-range radio transmit/radio receive facility KF2′ for this purpose according to the invention and a second short-range radio transmit/radio receive facility KF2 will similarly be integrated in the bank ATM.

It can be seen from the exemplary embodiment illustrated that in a third step 3 the form VD must be brought into the near field of the facilities BA and PC connected to the financial institution GI, in order to initiate payment processing.

The near field is hereby defined according to the invention by the first radio coverage area FV1, provided by the first short-range radio transmit/radio receive facility KF1. According to the invention it is hereby of particular advantage if this first radio coverage area FV1 is reduced where possible to a minimal radius by partial masking, in such a manner that the customer with the form VD must move very close to the facility BA, PC, preferably even holding said form VD up to a sensor surface provided for this purpose.

Alternatively the first radio coverage area may however only be reduced in such a manner that the presence of the customer in direct proximity to the facility BA, PC suffices, such that it is not necessary to take out the form VD, thereby preventing loss or spying by a third party similarly in proximity to the facility BA, PC.

By holding the form VD up to a sensor, it is possible however to prevent the simple action of passing close by the facility BA, PC triggering or possibly making a payment, which could result in the payment being made more than once, thereby debiting the account more than once or requiring an unreasonable effort on the part of the customer to reverse the transactions.

The invention therefore allows a particular degree of freedom in that it is possible to adapt to the respective requirements of the customer or financial institution by selecting the radius of the first radio coverage area FV1.

It is thereby also possible, alternatively or additionally, to define the near field by means of a second radio coverage area FV2, FV2′, provided by the second short-range radio transmit/radio receive facility KF2, KF2′. It is thus conceivable for example for the second radio coverage area FV2 to be reduced to a particularly significant degree for payment processing at a bank ATM BA, such that it is necessary to hold the form up to a sensor and payment cannot be triggered by the simple action of passing by, with the second radio coverage area FV2′ not having to be reduced to such a degree for use of the inventive method in the home area at the home PC, as in contrast to payment by way of the bank ATM BA, payment by way of the home PC does not require the second short-range radio transmit/radio receive facility KF2, KF2′ to be in constant operation but simply to be able and to have to be activated by the user when payment processing is required.

According to the exemplary embodiment it is possible, by bringing the form VD into the near field for example, for the payment only to be triggered by transmitting the payment-relevant data to the facility BA, PC on entry into the near area and inputting it automatically there into in input mask provided, it being possible for the payment procedure ultimately to be triggered by user input, which takes place for example at the home computer PC by operation of the input key, while at a bank ATM BA it may be triggered by a fingerprint sensor FS scanning the customer's fingerprint, to ensure that payment is also actually being made by the authenticated person. The biometric data determined is then compared with a reference variable stored in the financial institution GI, it being possible also to use biometric data, such as speech characteristics of the voice, iris features or even facial features as an alternative to the fingerprint.

Confirmation of this nature can also be followed, in particular at the home PC, by the display of data stored on the form VD, which is not payment-relevant but for example contains advertising content or general information relating to the payment procedure, viewing of which must be acknowledged, with said acknowledgement serving as confirmation as an alternative or in addition to the scanning of biometric data or user details. The scope of this content is thereby restricted to the storage capacity available on the first short-range radio transmit/radio receive facility, which should be deemed to be quite small with the RFID chip technology used in preference.

After confirmation, in a fourth step the payment-relevant data is transmitted to the financial institution GI, which debits the customer's account and makes the payment to the entity E.

1.-15. (canceled)

16. A method for payment processing, comprising:
by an entity issuing an invoice:
creating a payment form to be sent to a debtor;
including in the payment form data required to process the payment being input on the form;
integrating a first short-range radio transmit/radio receive facility with a storage facility in the payment form; and
storing the data on the storage facility such that, when the form is located within the short-range radio transmit/radio receive area of a facility embodied with a second short-range radio transmit/radio receive facility and communicating with a financial institution, the stored data is transmitted after detecting a first initiating action.

17. The method as claimed in claim 16, wherein the initiation occurs in response to an entry of the form into a near field of the second short-range radio transmit/radio receive facility.

18. The method as claimed in claim 17, wherein the near field is reducible by restriction of a transmit power of the second short-range radio transmit/radio receive facility.

19. The method as claimed in claim 16, wherein the initiation occurs in response to a user input at the facility communicating with the financial institution and at the form.

20. The method as claimed in claim 16, wherein the initiation occurs in response to a user input at the facility communicating with the financial institution or at the form.

21. The method as claimed in claim 16, wherein after the data has been transmitted, the data is automatically input into an input screen provided by the facility.

22. The method as claimed in claim 16, further comprising:
capturing a biometric data of the user;
comparing the captured biometric data with a stored biometric user data; and
forwarding the payment to the financial institution for processing if the comparing indicates the captured biometric data matches the stored biometric data.

23. The method as claimed in claim 22, wherein the biometric data is a finger print.

24. The method as claimed in claim 16, wherein facility is a bank ATM communicating with a bank communication network.

25. The method as claimed in claim 16, wherein the facility is a computer connected by way of a communication network is operated as the facility.

26. The method as claimed in claim 16, wherein further data is transmitted by the entity and it is realized as confirmation of the reading of said data in response to a second initiating action.

27. The method as claimed in claim 16, wherein the form is created as a form accepted by financial institutions.

28. A billhead generation facility for payment processing, comprising:
generating a payment form to be sent to a debtor;
integrating a first short-range radio transmit/radio receive facility having a storage facility in the payment form; and
storing data for processing the input on the storage facility in order to transmit the data after detecting an initiating action when the form is located within the short-range radio transmit/radio receive area of a facility,
wherein the facility is embodied with a second short-range radio transmit/radio receive facility and communicating with a financial institution.

29. A billhead, comprising:
data required to process a payment;
a payment form to be sent to a debtor; and
a first short-range radio transmit/radio receive facility having a storage facility integrated in the payment form,
wherein the data is stored on the storage facility in order to transmit the data after detecting an initiating action when the form is located within the short-range radio transmit/radio receive area of a facility, and
wherein the facility is embodied with a second short-range radio transmit/radio receive facility and communicating with a financial institution.

30. The billhead as claimed in claim 29, wherein the first short-range radio transmit/radio receive facility is embodied as an RFID.

31. The billhead as claimed in claim 29, wherein the second short-range radio transmit/radio facility is embodied such that its radio coverage area defines a near field by restriction of a transmit power of the facility.

32. An ATM facility for communicating with a financial institution, comprising:
providing second short-range radio transmit/radio receive facility;
receiving payment data from a payment form via the second short-range radio transmit/radio receive facility, the payment form includes the payment data and a first short-range radio transmit/radio receive facility in order to transmit data the payment data from the form; and
forwarding the payment data to the financial institution.

33. The ATM facility as claimed in claim 32, wherein the second short-range radio transmit/radio receive facility is embodied such that its radio coverage area defines the near field by a restriction of a transmit power of the second short-range radio transmit/radio receive facility.
